(19) United States
(12) Patent Application Publication
(10) Pub. No.: US 2002/0015116 A1
(43) Pub. Date: Feb. 7, 2002

(54) Optical system for head mounted display

(75) Inventor: Bu Go Park, Bucheon-si (KR)

Correspondence Address: LOWE HAUPTMAN GOPSTEIN, GILMAN & BERNER, LLP, SUITE 310, 1700 DIAGONAL ROAD, ALEXANDRIA, VA, 22314, US

(73) Assignee: Daeyang E&C Co., Ltd.

(21) Appl. No.: 09/916,263

(22) Filed: Jul. 30, 2001

(30) Foreign Application Priority Data
Jul. 31, 2000 (KR) 2000-44296

(51) Int. Cl. G02F 1/1335

(52) U.S. Cl. 349/9

(57) ABSTRACT

The present invention relates to a head mounted display that is constructed such that stereoscopic images can be seen on a liquid crystal display screen disposed adjacent to eyes. The present invention provides an optical system for a head mounted display, comprising a light source; an illuminating prism for controlling an optical path of light rays from the light source by reflecting and refracting the light rays; a polarizer for polarizing the light rays emitted from the illuminating prism; a polarization beam splitter for reflecting the polarized light rays emitted from the polarizer; a frontlight liquid crystal display screen on which images are displayed by means of the light rays reflected by the polarization beam splitter; and a free-form-surface prism disposed in front of the polarization beam splitter for magnifying the images on the liquid crystal display screen by reflecting and converging the light rays emitted from the liquid crystal display screen. According to the present invention, since the optical system for the head mounted display employs the frontlight liquid crystal display screen which is inexpensive and has a high pixel density, there is an advantage in that its production costs can be reduced. Further, the optical system includes the inexpensive light emitting diode, and the illuminating prism and the plurality of sheets for diffusing and focusing the light rays emitted from the light emitting diode, so that the use efficiency of the light source can be enhanced.

### BACKGROUND OF THE INVENTION

1. Field of the Invention

The present invention relates to a head mounted display which is constructed such that stereoscopic images can be seen on a liquid crystal display screen disposed adjacent to eyes, and more particularly, to an optical system for the head mounted display wherein its production costs can be reduced and best images can be provided to a wearer by enhancing use efficiency of a light source.

2. Description of the Prior Art

A head mounted display includes an optical system comprising a liquid crystal display screen, an illuminating device, lenses, etc. This optical system allows images to be displayed on the liquid crystal display screen and can be variously constructed depending on an arrangement of the components for constituting the optical system. Examples of the optical system used generally in the prior art are schematically shown in FIGS. 1 and 2. Taking the figures into consideration, the optical system of FIG. 1 is constructed in such a manner that an illuminating device 2 serving as a light source of a liquid crystal display screen 1 for displaying images is disposed behind the liquid crystal display screen 1 and that an eye lens 3 is disposed in front of the liquid crystal display screen 1.

Further, the optical system of FIG. 2 is constructed in such a manner that a liquid crystal display screen 1 is horizontally disposed to face downward, that a polarization beam splitter 4 is disposed at an angle of about 45° and vertically below the liquid crystal display screen 1, and that a concave reflecting mirror 5 for magnifying and reflecting an image displayed on the liquid crystal display screen 1 is disposed behind the polarization beam splitter 4. Here, an illuminating device 2 is also disposed behind the liquid crystal display screen 1 in the same manner as in FIG. 1. Furthermore, the liquid crystal display screens 1 of FIGS. 1 and 2 are backlight liquid crystal display screens and can be used to display the image by using the illuminating device 2, disposed behind the screens, as a light source.

Although the conventional optical systems constructed as such have advantages in that their constitutions are simple and thus their production costs are low, there are still disadvantages in that the eye lens 3 should be thick since a focal length thereof must be shortened to realize a large screen and that it is necessary to secure sufficient spaces for installing the illuminating device 2 and the polarization beam splitter 4. In particular, although the optical system of FIG. 2 has a more advantageous effect than the optical system of FIG. 1 in that image visibility thereof can be enhanced by means of the polarization beam splitter 4, there is a problem in that a wearer's own eye shape is reflected onto and seen from the concave reflecting mirror 5.

Another example of an optical system for a head mounted display is shown in FIG. 3. This optical system is constructed in such a manner that a liquid crystal display screen 1 is disposed to face downward at an angle of about 45°, an illuminating device 2 is disposed behind the liquid crystal display screen 1, and a free-form-surface prism 6 is disposed in front of the liquid crystal display screen 1. The liquid crystal display screen 1 is also a backlight liquid crystal display like those of FIGS. 1 and 2. The liquid crystal display screen 1 is constructed in such a manner that it displays an image by using the illuminating device 2, disposed behind the screens, as a light source and that light rays emitted from the liquid crystal display screen 1 are directed to a plane of incidence of the free-form-surface prism 6. On the other hand, the free-form-surface prism 6 is a polyhedron having a plane of incidence 6a, a plane of reflection 6b and a light-emerging plane 6c. As viewed from the outside, the plane of incidence 6a and the light-emerging plane 6c are concave while the plane of reflection 6b is convex. The free-form-surface prism 6 serves to magnify the image on the liquid crystal display screen 1 by reflecting and converging the light rays emitted from the liquid crystal display screen 1. That is, the light rays, which have been emitted from the liquid crystal display screen 1 and then are incident on the plane of incidence 6a, are reflected by the plane of reflection 6b and the light-emerging plane 6c and subsequently are converged into a focus, as shown in FIG. 3. Thus, there is an effect that the eyes of the wearer seem to view a large screen.

On the other hand, since the optical system of FIG. 3 constructed as such has a constitution in which its components are arranged nearly vertically, it is not necessary to secure large horizontal spaces. Thus, it has an advantage of its slimness and compactness. However, there is a shortcoming in that the production costs are increased since the expensive backlight liquid crystal display screen 1 should be used. Further, there is also another shortcoming in that a light source having a large area is required since the light source should be provided to an entire rear surface of the backlight liquid crystal display screen 1.

### SUMMARY OF THE INVENTION

Accordingly, the present invention is contemplated to solve the above problems. An object of the present invention is to provide an optical system for a head mounted display, wherein the structure of the optical system is improved so that inexpensive parts can be used therein and thus its production costs can be reduced, and wherein the structure of a light source is improved so that use efficiency of the light source can be enhanced and thus best images can be provided to a wearer.

In order to achieve the above object, the present invention provides an optical system for a head mounted display, comprising a light source; an illuminating prism for controlling an optical path of light rays from the light source by reflecting and refracting the light rays; a polarizer for polarizing the light rays emitted from the illuminating prism; a polarization beam splitter for reflecting the polarized light rays emitted from the polarizer; a frontlight liquid crystal display screen on which images are displayed by means of the light rays reflected by the polarization beam splitter; and a free-form-surface prism disposed in front of the polarization beam splitter for magnifying the images on the liquid crystal display screen by reflecting and converging the light rays emitted from the liquid crystal display screen.

### BRIEF DESCRIPTION OF THE DRAWINGS

FIG. 1 is a schematic view showing the constitution of a conventional optical system for a head mounted display.

FIGS. 2 and 3 are schematic views showing the other examples of conventional optical systems for a head mounted display.

FIG. 4 is a schematic view showing the constitution and arrangement of an optical system for a head mounted display according to the present invention.

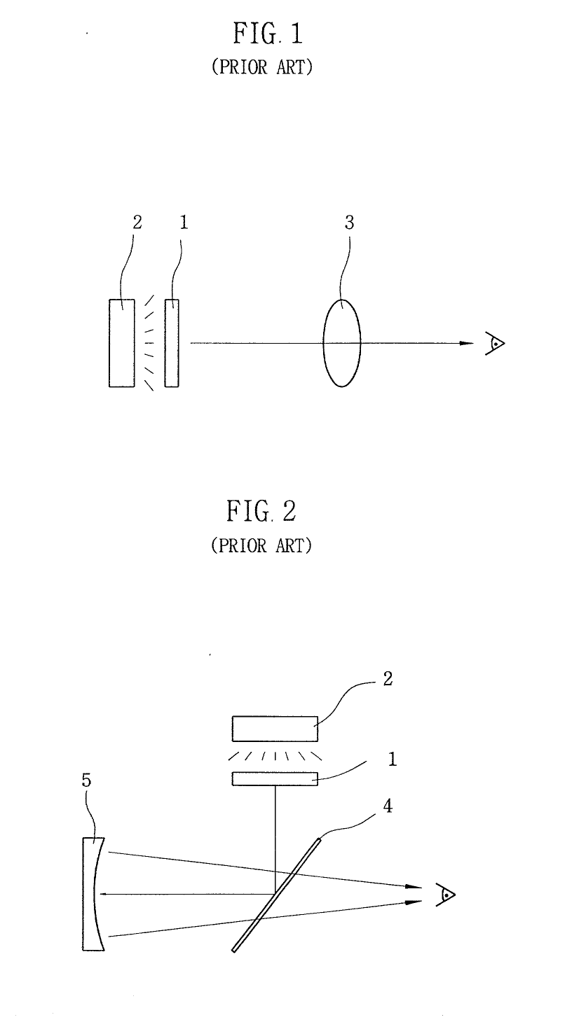

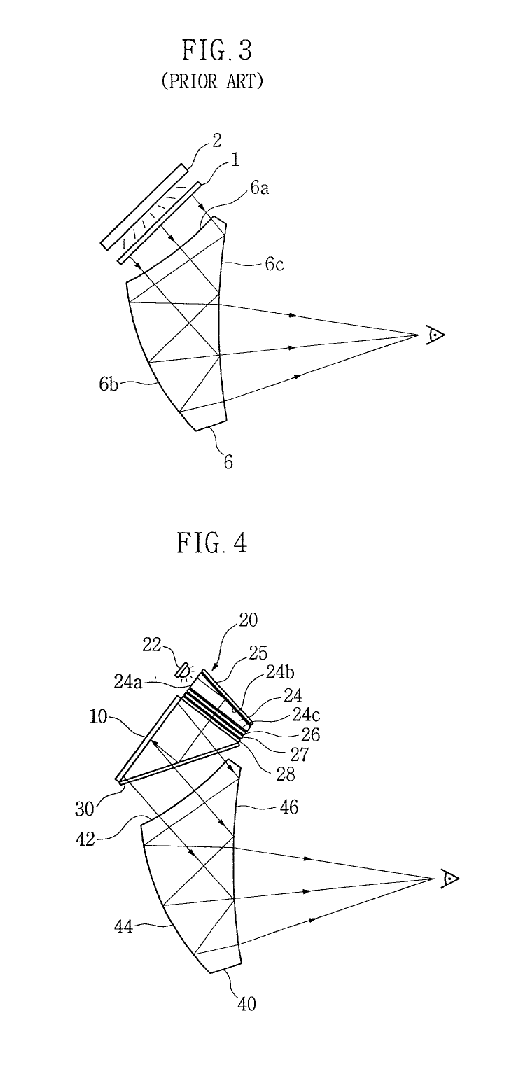

### DETAILED DESCRIPTION FOR PREFERRED EMBODIMENT

Hereinafter, a preferred embodiment of an optical system for a head mounted display according to the present invention will be explained in detail with reference to the accompanying drawings.

FIG. 4 is a view showing schematically the constitution and arrangement of the optical system for the head mounted display according to the present invention. First, as shown in FIG. 4, the optical system for the head mounted display according to the present invention includes a liquid crystal display screen 10 as a component thereof for displaying an image. The liquid crystal display screen 10 is a high pixel density frontlight liquid crystal display screen for displaying the image by using irradiation from a light source disposed in front of the screen, and is disposed to face downward at an angle of about 45°. Since the frontlight liquid crystal display screen has been well known, the detailed description thereof will be omitted.

Further, an illuminating portion 20 serving as the light source to the liquid crystal display screen 10 is disposed above the liquid crystal display screen 10. The illuminating portion 20 is mainly comprised of a light emitting diode 22, an illuminating prism 24, and a plurality of sheets 25 to 28. More specifically, the light emitting diode 22 that is a red/green/blue (RGB) light emitting diode is disposed in parallel with the liquid crystal display screen 10 and vertically above the screen 10, and the illuminating prism 24 is installed in front of the light emitting diode 22. The RGB light emitting diode 22 serves as the light source of the liquid crystal display screen 10, and the illuminating prism 24 serves to reflect light rays of the light emitting diode 22, which are incident on a plane of incidence 24a, by a plane of reflection 24b so that the reflected light rays emerge downward from a light-emerging plane 24c.

Furthermore, the plane of reflection 24b of the illuminating prism 24 is provided with the reflector sheet 25 for reflecting again the light rays, which are directly transmitted by the illuminating prism 24, so as to prevent leakage of the light rays in undesired directions. The diffuser sheet 26 for diffusing the light rays refracted by the illuminating prism 24, the prism sheet 27 for focusing the light rays emitted again through the diffuser sheet 26 within a predetermined range of angles, and a polarizer 28 for obtaining light rays having a predetermined linearly polarized component from the light rays emitted from the prism sheet 27 are sequentially disposed below the light-emerging plane 24c of the illuminating prism 24. In particular, the diffuser sheet 26 serves to uniformly diffuse the light rays emitted from the illuminating prism 24 and to uniformly deliver them over the entire surface of the prism sheet 27. The prism sheet 27 serves to focus the diffused light rays within the predetermined range of angles so as to enhance brightness of the liquid crystal display screen 10. These reflector sheet 25, diffuser sheet 26, prism sheet 27 and polarizer 28 allow the light rays emitted from the light emitting diode 22 to be greatly used, and thus, enhance use efficiency of the light source.

On the other hand, a polarization beam splitter 30 is disposed in front of the liquid crystal display screen 10 to form an angle of about 35° therebetween, as shown in FIG. 4. The polarization beam splitter 30 splits the linearly polarized light rays emitted from the polarizer 28 and then reflects them toward the liquid crystal display screen 10. Since the polarization beam splitter 30 has been well known, the description of its constitution and function will be omitted.

Further, a free-form-surface prism 40 is disposed in front of the polarization beam splitter 30 for magnifying the image on the liquid crystal display screen 10. The free-form-surface prism 40 is a polyhedron having a plane of incidence 42, a plane of reflection 44 and a light-emerging plane 46. The plane of incidence 42 and the light-emerging plane 46 are concave while the plane of reflection 44 is convex. The free-form-surface prism 40 is vertically disposed with the plane of incidence 42 placed in front of the polarization beam splitter 30, and serves to magnify the image on the liquid crystal display screen 10 which is introduced through the plane of incidence 42. Particularly, the light rays of the image on the liquid crystal display screen 10 are reflected many times by the concave plane of incidence 42, the concave light-emerging plane 46 and the convex plane of reflection 44. After the light rays emerge from the light-emerging plane, they converge into a predetermined focus. Thus, the image on the liquid crystal display screen can be magnified.

With such constitution, when the light rays are emitted from the light emitting diode 22 with predetermined image signals applied to the liquid crystal display screen 10, an optical path of the emitted light rays is controlled by the illuminating prism 24 so that the light rays are irradiated onto the polarization beam splitter 30. At this time, light rays which have been transmitted directly by the illuminating prism 24 and leaked out in undesired directions are reflected by the reflector sheet 25 and irradiated onto the polarization beam splitter 30. The light rays which emerge from the light-emerging plane 24c of the illuminating prism 24 are diffused and focused by the diffuser sheet 26, the prism sheet 27 and the polarizer 28 and then have the predetermined polarized components. The polarization beam splitter 30 is constructed such that it reflects the light rays having the predetermined polarized components by passing through the polarizer 28. Thus, the light rays reflected by the polarization beam splitter 30 are irradiated onto the liquid crystal display screen 10. Accordingly, the liquid crystal display screen 10 can display the image by using the light rays of the illuminating portion 20 as the light source.

On the other hand, the light rays of the image on the liquid crystal display screen 10 are transmitted through the polarization beam splitter 30 and are incident on the free-form-surface prism 40. The light rays of the image which has been incident on the free-form-surface prism 40 are reflected many times by the plane of incidence 42, the plane of reflection 44 and the light-emerging plane 46. Finally, when the light rays emerge forward from the light-emerging plane 46, they converge into the predetermined focus. Thus, a wearer of the head mounted display can view an image magnified from the image on the liquid crystal display screen 10, through the light-emerging plane 46 of the free-form-surface prism 40.

As described above, since the optical system for the head mounted display of the present invention employs the frontlight liquid crystal display screen which is inexpensive and has a high pixel density, there is an advantage in that its production costs can be reduced. Further, the optical system includes the inexpensive light emitting diode, and the illuminating prism and the plurality of sheets for diffusing and focusing the light rays emitted from the light emitting diode, so that the use efficiency of the light source can be enhanced to the utmost. Thus, there is another advantage in that more vivid and clearer images can be provided to the wearer.

The above-mentioned embodiment is merely a preferred embodiment of the present invention, and is not to be construed as limiting the scope of the present invention. Various modifications and changes can be made thereto within the spirit of the present invention. Therefore, the scope of the present invention should be defined by the appended claims and equivalents thereof.

What is claimed is:

1. An optical system for a head mounted display, comprising:
a light source;
an illuminating prism for controlling an optical path of light rays from said light source by reflecting and refracting said light rays;
a polarizer for polarizing said light rays emitted from said illuminating prism;
a polarization beam splitter for reflecting said polarized light rays emitted from said polarizer;
a frontlight liquid crystal display screen on which images are displayed by means of said light rays reflected by said polarization beam splitter; and
a free-form-surface prism disposed in front of said polarization beam splitter for magnifying said images on said liquid crystal display screen by reflecting and converging said light rays emitted from said liquid crystal display screen.

2. The optical system for the head mounted display as claimed in claim 1, wherein said light source is a light emitting diode which is disposed in parallel with said liquid crystal display screen at an external side thereof.

3. The optical system for the head mounted display as claimed in claim 1, further comprising:
a reflector sheet attached to a plane of reflection of said illuminating prism for reflecting again light rays, which are transmitted by said plane of reflection and emerge outward from said illuminating prism, toward the interior of said illuminating prism;
a diffuser sheet attached to a light-emerging plane of said illuminating prism for diffusing said light rays emitted from said illuminating prism; and
a prism sheet disposed between said diffuser sheet and said polarizer for converging said light rays emitted from said diffuser sheet within a predetermined range of angles.
